(19) United States
(12) Patent Application Publication
(10) Pub. No.: US 2013/0070603 A1
(43) Pub. Date: Mar. 21, 2013

(54) LINK-STATE ROUTING METHOD FOR ROUTING DATA STREAMS IN A MESHED NETWORK COMPRISING NODES CONNECTED BY THREE-STATE LINKS

(71) Applicants: Sinda Sahaly, Rennes (FR); Philippe Christin, Rennes (FR)

(72) Inventors: Sinda Sahaly, Rennes (FR); Philippe Christin, Rennes (FR)

(73) Assignee: France Telecom, Paris (FR)

(21) Appl. No.: 13/698,834

(22) PCT Filed: May 19, 2011
(86) PCT No.: PCT/FR2011/051138

§ 371 Date: Nov. 19, 2012

(30) Foreign Application Priority Data
May 20, 2010 (FR) 1053928

(51) Int. Cl. H04L 12/26

(52) U.S. Cl. 370/237

(57) ABSTRACT

A link-state routing method for routing a data stream in a meshed communications network comprising a plurality of nodes connected by links, at least one node of said network comprising a topology table which comprises at least one link, in which the node implements: a step of measuring a parameter relating to the load on said link, a step of comparison of the measured load parameter with a predetermined overload threshold, an overload state being assigned to said link when said overload threshold is exceeded by said load parameter; and a step of distributing an item of information relating to said overload state of said link to at least some of the nodes of said network.

The present invention relates to the field of data routing between nodes of a communications network.

A communications network conventionally comprises a plurality of nodes which are connected to each other in order to form a meshed network. Such nodes can be data processing terminals of the IP (Internet Protocol) type, core network equipment, a home gateway, etc. A link connects a source node to a destination node.

A link is in the form of a data connection which can be wired (Ethernet, optical fiber, PLC (Power Line Communication), etc.) or wireless (for example based on the radio network standard IEEE 802.11 and its evolutions, grouped under the name WiFi (Wireless Fidelity) (Wifi 802.11 a, 802.11n, etc.)).

In order to exchange data between a source node and a destination node of the meshed network, it is necessary to determine the path the data must take in the network from this source node to this destination node. A path is defined by the sequence of links and nodes through which the data flow in the communications network. A routing protocol makes it possible to determine the best path for conveying data between a source node and a destination node. Conventionally, each node of the communications network comprises a routing table which is updated by the routing protocol from the topology table of the network comprising all of the links constituting the network.

Link-state routing protocols, such as OSPF (Open Shortest Path First) and OLSR (Optimized Link State Routing), known to those skilled in the art, make it possible to construct routing tables of nodes in order to correctly convey the data between the source node and the destination node.

In a link-state routing protocol, in order to define the best path connecting two distant nodes, each link is characterized by at least two parameters: a state and a metric.

Traditionally, a link has two states: an active state, called “UP”, in which the link is usable for sending data between two neighboring nodes, and an inactive state, called “DOWN”, in which no data traffic is possible. The state of the link allows a routing protocol to determine if the link is usable in order to form a path. Conventionally, only the active links are referenced in the topology table of a node.

In a known way, an active link has a metric which characterizes it, such as the data rate, the link delay or jitter. The metric of the link allows a routing protocol to compare the paths with each other and to select, as a priority, the paths having the best metric from end to end, that is to say over all of the links which form them.

Thus, a node of the communications network conventionally comprises a topology table in which each active link of the network is indexed with its metric, an inactive link not being indexed. An algorithm of the Djikstra type, known to those skilled in the art, makes it possible to determine the shortest path between a source node and a destination node from the topology table in the source node. The best paths for each destination node are grouped in the routing table of the source node, the routing table indicating on which link the data must be routed for a given destination node. In other words, the routing table of the source node indicates, for each destination node, which link from the source node must be used for conveying the data.

The routing table is calculated from the topology table which is updated by sending topology messages between the nodes of the network. Thus, when a link becomes inactive (DOWN), topology messages are distributed by the nodes in order that the information relating to the inactivity of the link is known by all of the nodes. The topology and routing tables of the nodes are then updated. After the distribution of topology messages between the nodes, the nodes of the network all have the same topology table.

In the case of a home network which is installed, for example, in the homes of individuals, the meshing of the network is simple. Conventionally, the home network comprises a home gateway connected to the internet and a plurality of data processing terminals (portable computer, office computer, television decoder, also called “set-top box”) which are connected directly to the home gateway. Such a home network is called a star network, the home gateway forming the center of the star.

Because of the increase in data rates for home gateways, it is now possible to send data of different types (video, music, home automation, etc.) to remote terminals situated in various places in a house (living room, bedroom, kitchen, etc.). In order to allow optimum data transmission, conventional star networks necessitate a structured wiring which is often non-existent. In practice, several alternative heterogeneous technologies are used in parallel in a home network, such as PLC, WiFi and similar technologies. The routing of data in the home network is not optimal.

In order to transmit a high data rate between the home gateway and the set-top box, the link between the home gateway and the set-top box must not be saturated. A link is considered to be saturated when the data rate at the output of the link is less than the data rate at the input of that link. Data are lost during transmission on a saturated line. By way of example, for the transmission of a video stream, saturation of the link results in the loss of video frames, which degrades the viewing of the video stream by the user. The greater the number of data streams transmitted over a same link, the greater the probability of saturation of the link.

The disadvantage of present-day link-state routing protocols is that they are not designed for reacting gradually to a saturation of a link. In fact, as long as a link is active (UP) in the topology table, that link can be used according to the routing table of the node and data streams can be transmitted on said link. If a link is saturated, it is considered as inactive and is withdrawn from the topology table and from the routing table of the node. No data stream can then be transmitted on that saturated link.

A link-state routing protocol using dynamic metrics could be used. According to this type of routing, the more a link becomes saturated, the lower its metric becomes. In other words, the metric of the link varies according to the data traffic. When a first link is saturated, the data streams of the first link are redirected to a second link whose metric is better than that of the first link. When the second link is of the same type as the first link (similar technology, similar data rate, etc.) the second link saturates in its turn and its metric is penalized. The data streams of the second link are therefore redirected to the first link whose metric has improved in the absence of data traffic. Over time, the data stream will be alternately switched between the first and second links. This results in a phenomenon of data stream oscillation. The problem of saturation is thus passed on from link to link. A routing protocol with dynamic metrics does not therefore make it possible to solve the problem of saturation of a link in a meshed network.

It will be noted that this problem is not unique to home networks, described here by way of simple example, but can occur in any type of communications network.

In order to eliminate at least some of these disadvantages, the invention relates to a link-state routing method for routing a data stream in a meshed communications network comprising a plurality of nodes connected by links, at least one node of said network comprising a topology table which comprises at least one link, in which the node implements:
a step of measuring a parameter relating to the load on said link,
a step of comparison of the measured load parameter with a predetermined overload threshold, an overload state being assigned to said link when said overload threshold is exceeded by said load parameter; and
a step of distributing an item of information relating to said overload state of said link to at least some of the nodes of said network.

The term “load parameter” is understood to mean the ratio of a data rate measurement to the maximum data rate that can be supported by said link. For a wireless link, for example of the WiFi type, the load parameter can correspond to the percentage occupation of the bandwidth of said link by a data stream.

In a routing method according to the prior art in which the links have only two states (active or inactive), a data stream is transmitted according to said routing table without taking account of the load state of the network.

Because of the routing method according to the invention, in which the link has three potential states (active, inactive, overload), the overload state of a link makes it possible to influence the routing of data on the network. The detection of an overloaded link by a node of the network is distributed to the other nodes of the network, which allows each node to adapt itself in order to avoid saturation of the overloaded link. For example, a node can continue to send on the overloaded link the streams which are already flowing in it and can send the new streams on another link.

According to an aspect of the invention, the node implements a step of updating its topology table from said item of information relating to the overload state of said link.

Thus, the node which detects a link in the overload state can directly update its topology table, which makes it possible to modify the formation of its routing table. The conveying of data streams by said node can then take account of the overload state of the link and avoid saturation of the link.

According to an embodiment, the node of said network comprises a routing table, constructed from the updated topology table, comprising at least one path leading to a destination node, and the node implements a step of storage of the overload state of said path in the routing table.

The paths of the routing table which are overloaded are advantageously indicated in the routing table. Thus, when a data stream must be conveyed on an overloaded path, the stream can be diverted to another path or not be transmitted. Saturation of the overloaded link is thus avoided.

According to an aspect, when the routing table comprises a path in the overload state leading to a destination node, the node adds to its routing table another path leading to said destination node.

During the formation of the routing table from the topology table, the node advantageously forms a path bypassing the overloaded path. Thus, if a data stream must be conveyed on an overloaded path, the stream can be conveyed on an alternative path. The capacity of the network is thus used in an optimal manner.

Preferably, the node implements a step of storage in its routing table of an identifier of a data stream flowing on said path.

The storage of the data stream flowing on a path advantageously makes it possible to prevent other streams from being conveyed on the overloaded path, the latter being reserved for the stream or streams flowing on it. Thus the method allows a control of admission of data streams onto the overloaded path.

According to an aspect of the invention, the node implements:
a step of comparison of the load parameter of said overloaded link with a predetermined active threshold, an active state being assigned to said link if said load parameter is lower than said active threshold, and
a step of updating its topology table from an item of information relating to the active state of said link.

The topology table is updated as a function of the load parameter measured on said link in order to determine if the link is still overloaded. When the link is no longer overloaded, the topology table indicates that the path is no longer overloaded and the transmission of the data stream by said method is no longer selective. Thus, these steps advantageously make it possible to limit too frequent switchings between the active state and the overload state and oscillatory switching is thus avoided. In other words, these steps advantageously make it possible to introduce a time delay, or hysteresis, between two switchovers.

The invention also relates to a link-state routing method for routing a data stream in a meshed communications network comprising a plurality of nodes connected by links, at least one node of said network comprising a topology table which comprises at least one link, in which the node implements:
a step of receiving an item of information relating to the overload state of said link transmitted by at least one other node of the network, and
a step of updating by said node of its topology table, from said item of information relating to the overload state of said link.

The information relating to the overload state of said link is distributed to some of the nodes of the network, which makes it possible for the latter to update their topology table and to modify the conveying of data on the meshed network in order to take account of the overloaded link. In other words, all of the nodes of the network can take account of the overloaded link, this information not being reserved for the node having detected the overload.

It follows that any node of the network, whether it is a node detecting an overload or a node receiving the overload information, can implement the previously mentioned steps (updating the routing table, formation of a bypass path, storage of data streams, etc.). It also follows that the steps can be implemented simultaneously or sequentially.

The invention also relates to a node of a meshed communications network comprising a plurality of nodes connected by links, the node comprising a topology table comprising at least one link, means of measuring a load parameter on said link, means of comparison of the measured load parameter with a predetermined overload threshold, an overload state being assigned to said link in the case of said load parameter exceeding said overload threshold and means of distributing to at least some of the nodes of said network an item of information relating to said overload state of said link.

The node of the meshed communications network makes it possible to define three potential states for a link (active, inactive, overload), the overload state of a link making it possible to influence the routing of data on the network. The node can thus warn the other nodes in order that they adapt themselves to avoid saturation of the overloaded link.

The invention also relates to a node of a meshed communications network comprising a plurality of nodes connected by links, the node comprising a topology table comprising at least one link, means of receiving an item of information relative to the overload state of said link transmitted by at least one other node of the network and means of updating its topology table from said item of information relating to the overload state of said link.

The overload state of said link information is received by the node, which makes it possible for it to update its topology table and to modify the conveying of data on the meshed network in order to take account of the overloaded link. All of the nodes of the network can thus take account of the overloaded link, this information not being reserved for the node having detected the overload.

The invention also relates to a computer program comprising instructions for the implementation of a routing method when the program is executed by a processor as well as to a recording medium in which said program is stored.

The invention also relates to a signal transmitted by a source node of a meshed communications network, comprising a plurality of nodes connected by links, to at least one destination node of said network, the destination node comprising a topology table comprising at least one link, the signal conveying a topology message intended for updating the topology table of the destination node, in which the topology message comprises a field giving information on the overload state of the link of the topology table.

The updating of the topology table of a node of the network is facilitated because the overload information is directly included in a topology message. The signal conveying the overload state of a link is united with the routing method given that both of them aim to communicate an overload state of a link in order to form a topology table making it possible to avoid saturation of the overloaded link.

The invention also relates to a topology table of a node of a meshed communications network which comprises at least one link, the topology table comprising a field in which the overload state of said link is defined. Similarly, the invention also relates to a routing table of a node of a meshed communications network which comprises at least one path, the routing table comprising a field in which the overload state of said path is defined.

Other features and advantages of the invention will become apparent during the following description, given with reference to the appended figures which are given as non-limiting examples:

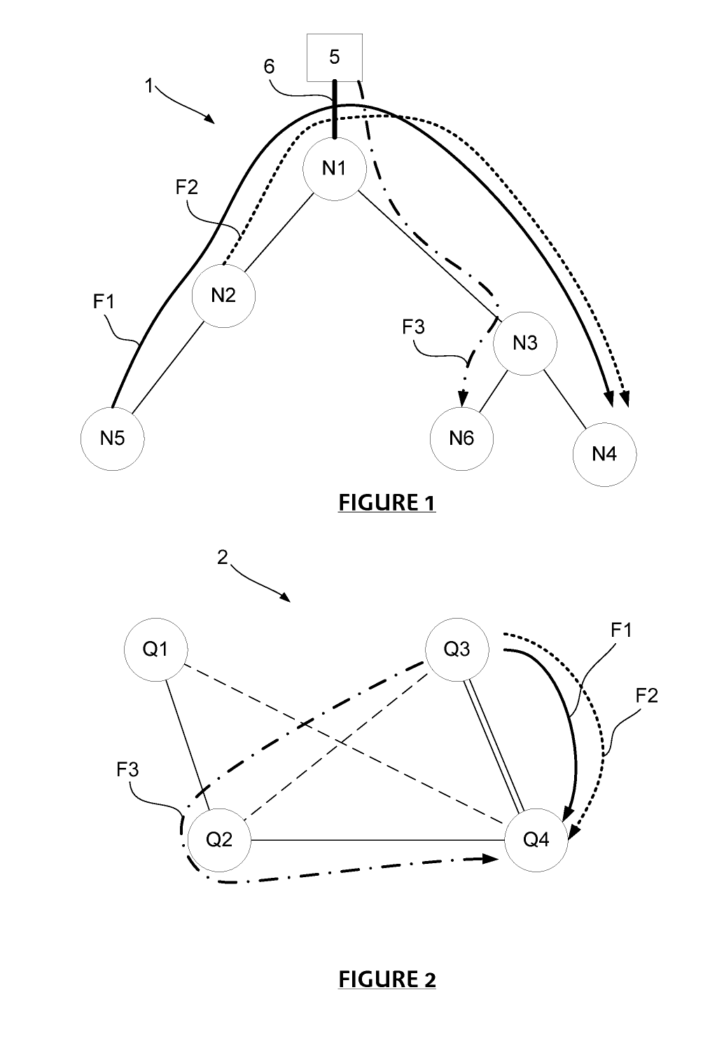

FIG. 1 is a diagrammatic representation of data stream routing according to the invention in a first communications network;

FIG. 2 is a diagrammatic representation of data stream routing according to the invention in a second communications network;

FIG. 3 is a diagrammatic representation of data stream routing according to the invention in a third communications network which is a home network; and

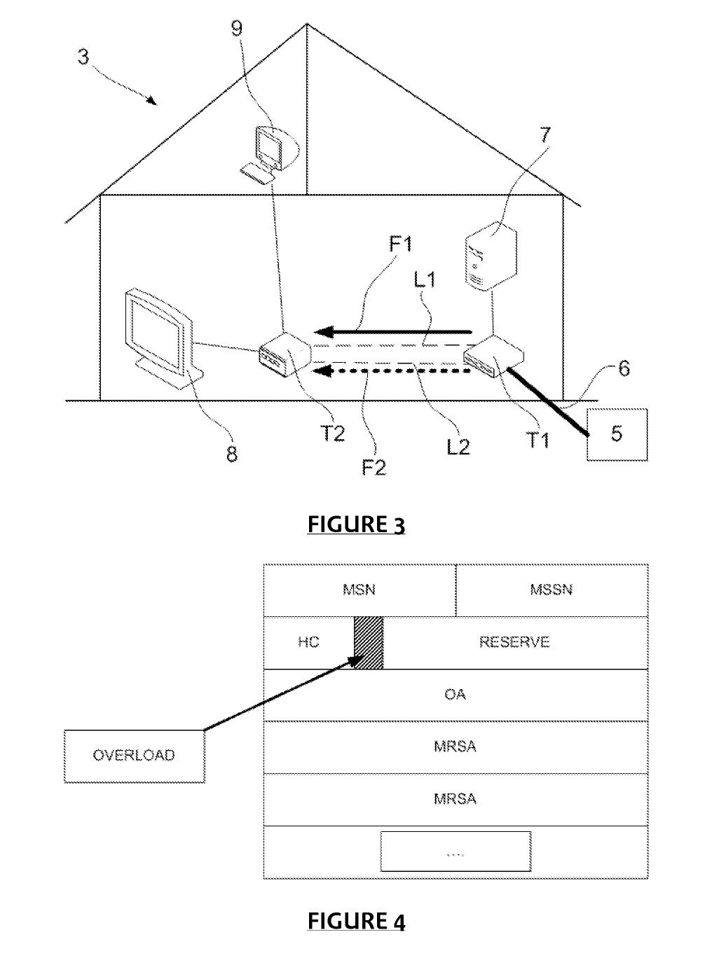

FIG. 4 is a representation of a topology message with an item of information relating to the overload state of a link.

With reference to FIG. 1, a meshed communications network 1 comprises six nodes N1-N6, connected with each other by wire links of the same kind, of the Ethernet type, each link having the same metric. The node N1 is connected to the internet network 5 by a connection 6 of the FTTH (Fiber To The Home) type which guarantees a high data rate of the order of one Gigabit/s. The nodes are in the form of data processing terminals suitable for routing data streams on the meshed network. The node N1 is for example a home or domestic gateway or, more generally, an entry gateway in a local network, for example an enterprise local network.

Each node N1-N6 has a topology table, which is unique to it and whose content is identical to that of the tables of the other nodes, in which the topology of the network is defined. As mentioned above, each active link is indexed with its metric in the topology table. In this example, the links between the nodes are all active.

Each node N1-N6 also has a routing table, which is unique to it, in which the paths to reach each node of the network are defined. As mentioned above, a path is defined by the sequence of links and of nodes through which the data flows in the communications network. The routing table of a node is constructed from the topology table of said node. A path of the routing table comprises the identifier of the first link to be used, the metric from end to end of the path and the indication of an overload of any link on that path.

A first data stream, denoted F1 in FIG. 1, is transmitted by the node N5 of the meshed network 1 with the node N4 as its destination. The routing table of the node N5 indicates that in order to reach the node N4, the first data stream F1 must be conveyed through the node N2 and that no saturated link is detected on the path leading to the destination N4. As all of the links on the path N5/N4 are active, the first stream F1 is transmitted on this path by the node N5.

In this embodiment, each node N1-N6 measures on its links a load parameter of the link. “Load parameter” is understood to be the ratio between a measurement of the capacity used to the maximum capacity that can be supported by said link. By way of example, for a wireless link of the WiFi type, the load parameter can correspond to the percentage occupation of the bandwidth of said link by a data stream.

Thus, by way of example, the node N5 measures the load parameter of the link [N5, N2] at regular time intervals. Similarly, the node N1 measures the load parameter of the links [N1, N3] and [N1, N2]. Still by way of example, the load parameter measured for each of the links through which the first stream F1 passes is equal to 40%. In other words, in a particular embodiment where the load parameter depends on the data rate of the link, the data rate of the first stream F1 uses 40% of the maximum data rate authorized on each of the links.

According to the method according to the invention, a node compares the measured load parameter with a predetermined overload threshold M. By way of example, the overload threshold is here equal to 75% such that a link is assigned an overload state (OVERLOAD) when the threshold M is exceeded whilst preventing said link from becoming saturated when the overload threshold M is exceeded. In other words, if a link is considered to be saturated when its load parameter is equal to 95%, an overload threshold equal to 75% makes it possible to provide a load margin (of the order of 20%). Because of this margin, the link can accept an additional data stream which modifies the link state without by so doing saturating the link.

After the transmission of the first stream F1, none of the load parameters measured by the nodes N1-N6 exceeds the overload threshold M and the topology and routing tables of the nodes are not modified.

A second data stream, denoted F2 in FIG. 1, is transmitted by the node N2 of the meshed network 1 with the node N4 as its destination. The routing table of the node N2 indicates that, in order to reach the node N4, the second data stream F2 must be conveyed through the node N1. As all of the links on the path N2/N4 are active, the second stream F2 is transmitted on this path.

The node N5 recalculates the load parameter on the link [N5, N2] which does not vary following the transmission of the second stream F2 given that the second stream F2 does not flow on this link. The node N1 recalculates the load parameter of the links [N1, N3] and [N1, N2]. As the first stream F1 and the second stream F2 flow on the link [N1, N3], a load parameter equal to 80% is measured by the node N1.

After the transmission of the second stream F2, the load parameter of each link is compared with the overload threshold M equal to 75%. The link [N1, N3] which has a load parameter equal to 80%, higher than 75%, is declared to be overloaded (OVERLOAD) whilst the other links remain active (UP).

The node N1 updates its topology table to indicate that the link [N1, N3] has an overload state (OVERLOAD). For this purpose, the state of the link [N1, N3] changes from “UP” to “OVERLOAD” in the topology table of the node N1.

The node N1 also distributes this information relating to the overload state of the link [N1, N3] to the other nodes of the network 1 so that the latter can update their topology tables. Thus, after this distribution, all of the nodes of the network have the same topology table.

By way of example, the node N1 distributes to the other nodes of the network 1 a topology message comprising a field identifying the link [N1, N3], a field relating to the metric of the link and a field relating to the overload state of the link [N1, N3]. The destination nodes N2-N6 of the topology message update their topology table in a way similar to the node N1. The routing tables of the nodes N1-N6 are then updated from the topology tables so as to indicate the overloaded paths.

The routing table of N1 indicates in particular that the path leading to the node N4 is overloaded.

The paths of the routing table which include a path with an overloaded link are qualified as paths in the overload state.

Because of the overload threshold M equal to 75%, the acceptance of the second data stream F2 makes it possible to exceed the overload threshold M (load parameter higher then 75%) without saturation (load parameter lower than 95%).

In this implementation of the invention, when a node conveys a data stream on a path in its routing table, the node stores the data stream by associating the identifier of the data stream with the path on which it is conveyed. Thus, with reference to FIG. 1, the routing table of N1 comprises, in addition to the fields already described, a column in which the transmitted data streams F1 and F2 are identified.

The first stream F1 and the second stream F2, stored in the routing table of the node N1, flow on the link [N1, N3] before the link is declared to be overloaded. The streams F1, F2 are considered as authorized streams and the change of state of the link does not affect the routing of the streams F1, F2. Thus, when data packets of the data stream F2 have to be conveyed through the node N1 with the node N4 as destination, the packets are routed through the node N3 without taking account of the overload state of the link [N1, N3].

A third data stream, denoted F3 in FIG. 1, is transmitted by the node N1 of the meshed network 1 with the node N6 as its destination. The routing table of the node N1 indicates that in order to reach the node N6, the third data stream F3 must be conveyed through the node N3. As the link [N1, N3] is overloaded (OVERLOAD) and the meshed network 1 is a single-path network, no other path is available for bypassing the overloaded link and the third stream F3 is not conveyed through the node N1. In other words, the third data stream F3 is rejected since it cannot be conveyed as far as its destination without using an overloaded path.

The routing method according to the invention makes it possible, thanks to its overload state, to control the acceptance of data streams in the meshed network. Only the streams which are flowing on a link prior to the modification of its state are authorized. Only the authorized streams can flow on the overloaded links, any additional unauthorized stream being rejected. Thus, the overloaded link [N1, N3] is not saturated and no data is lost on the overloaded link [N1, N3]. The quality of service of the meshed network is thus improved.

According to an aspect of the invention, a node compares the load parameter of said overloaded link with a predetermined active threshold N. By way of example, the predetermined active threshold is equal to 60%. If the load parameter of said link is below said active threshold N, the link is not considered to be overloaded (OVERLOAD) and an active (UP) state is found. The node distributes a topology message to inform the other nodes of the network that the link is in the active state. The topology and routing tables of said nodes are then updated.

As the active threshold N is different from the overload threshold M, it is avoided that the state of the link is modified in an inconvenient manner when the link has a load parameter close to the overload threshold M. Thanks to the active threshold N, once the link is no longer overloaded, it again becomes operational and the conveying of new data streams on the meshed network via this link is allowed. The management of the overload state is dynamic thanks to the overload threshold M and to the active threshold N. This advantageously makes it possible to prevent oscillatory switching between the two link states.

In a particular embodiment of the invention, it would also be possible to envisage, as a variant, that the active threshold N and the overload threshold M are identical.

With reference to FIG. 2, a meshed communications network 2 comprises four nodes Q1-Q4, the links [Q1, Q2] and [Q2, Q4] being formed by an Ethernet link (represented by a single continuous line), the link [Q3, Q4] being formed by a so-called PLC (Power Line Communication) connection (represented by a double continuous line) whilst the other links are wireless links (represented by a single discontinuous line) which are based on the wireless network standard IEEE 802.11 and its evolutions, grouped under the name WiFi (Wireless Fidelity).

In the network of FIG. 2, the links do not have the same metric, an Ethernet link being better than a PLC link, which is itself better than a WiFi link in the sense of the particular metric considered here.

Each node Q1-Q4 has its own topology table and its own routing table in which the paths for reaching each node of the network are defined with the overload state of each path. In this example, the links between the nodes are all active.

A first data stream, denoted F1 in FIG. 1, is transmitted by the node Q3 of the meshed network 2 with the node Q4 as its destination. In order to reach the node Q4, the first data stream F1 can successively pass through:
the nodes Q3 and Q4 via the PLC link [Q3, Q4] which is active, or
the nodes Q3, Q2 and Q4 via the WiFi link [Q3, Q2] and the Ethernet link [Q2, Q4] which are active.

As the metric of the PLC link [Q3, Q4] is better than that of the WiFi link [Q3, Q2], the routing table of the node Q3 indicates that in order to reach the node Q4, the data must be conveyed through the PLC link [Q3, Q4] considered to be the best path.

The node Q3 measures the load parameter on the link [Q3, Q4] after the transmission of the first stream F1. The data rate of the first stream F1 uses 40% of the maximum authorized data rate on the link [Q3, Q4]. The load parameter of the link [Q3, Q4] is compared with the overload threshold M, equal to 75%.

As none of the load parameters of the nodes exceed the overload threshold M, the load states of the links of the topology table are not modified, the links remaining in the active state. In the routing table of the node Q3, the identifier of the first stream F1 is stored and associated with the path leading to the node Q4 passing through the link [Q3-Q4].

A second data stream F2 is transmitted by the node Q3 of the meshed network 2 with the node Q4 as its destination. For the same reasons as previously mentioned for the routing of the first data stream F1, as all of the links are active, the second stream F2 is conveyed on the link [Q3, Q4].

The first stream F1 and the second stream F2 flow on the link [Q3, Q4] which modifies the load parameter which is now equal to 80%. After the transmission of the second stream F2, the load parameter of each link is compared with the overload threshold M equal to 75%. The link [Q3, Q4] which has a load parameter equal to 80%, higher than 75%, is declared to be overloaded (OVERLOAD) whilst the other links remain active (UP).

The node Q3 transmits a topology message to inform the other nodes that the link [Q3, Q4] is overloaded. The nodes of the network 2 update their topology table and their routing table.

By way of example, the routing table of the node Q3 is modified such that the path leading to the node Q4 passing through the link [Q3, Q4] is declared to be overloaded (OVERLOAD). In the routing table of the node Q3, the identifier of the second stream F2 is stored and associated with the path on which it flows.

As previously described, the first stream F1 and the second stream F2 which are already flowing on the overloaded link are considered as authorized streams in the routing tables of the nodes Q3 and Q4 and the change of state of the PLC link [Q3, Q4] does not affect the routing of the streams F1, F2.

A third data stream, denoted F3 in FIG. 2, is transmitted by the node Q3 of the meshed network 2 with the node Q4 as its destination. As the path comprising the link [Q3, Q4] is overloaded, the third stream F3 cannot be conveyed through the link [Q3, Q4] as this would result in its saturation.

By consulting its topology table, the node Q3 observes that another path is available for bypassing the overloaded link, in particular passing through the nodes Q3, Q2 and Q4. From its topology table, the node Q3 calculates a new path leading to the node Q4 by considering that the overloaded links in the topology table are inactive links. The path-forming algorithm, for example an algorithm of the Djikstra type, will be modified in order to retain in the routing table the paths on which a data stream is flowing and to calculate a path bypassing the overloaded links in order to reach a given destination.

Thus, by way of example, as data streams F1, F2 are flowing on the link [Q3-Q4], the routing table of Q3 retains the path leading to Q4 via the link [Q3-Q4]. However, as this path is overloaded, the routing table also comprises a bypass path leading to Q4 via the link [Q3-Q2].

The routing method according to the invention makes it possible, thanks to its overload state (OVERLOAD), to use the whole of the capacity of the network in order to make it possible to take advantage of all of the links and thus to increase the volume and the rate of data rate able to be transmitted between the nodes Q3 and Q4.

In the meshed network 2, when a link is overloaded (OVERLOAD), a step of selection of the priority streams to be transmitted can be implemented, only the priority streams being transmitted on the overloaded link, the streams of lower priority being transmitted by the other paths which are not overloaded.

The method according to the invention can be used with any existing type of routing protocol in order to make it possible to improve the quality of service of a meshed network.

The method according to the invention has an advantageous application in local networks (home or enterprise) comprising different terminals of different natures (television, portable computer, multimedia station, office computer, etc.) connected with each other by links of different types (Ethernet, WiFi 802.11a, WiFi 802.11n, PLC, etc.).

By way of example, the method according to the invention can be used with a so-called OLSR (Optimized Link State Routing) protocol known to those skilled in the art. The OLSR protocol is a network layer protocol (layer 3 of the OSI model) defined in the RFC 3626 standard.

The OLSR protocol is defined to make it possible to interface with nodes comprising wireless interfaces, which is a feature of conventional local networks. However, other routing protocols could also be used for local networks.

Conventionally, the OLSR protocol is based on two-state links: “UP” and “DOWN”. The two states “UP” and “DOWN” are implicitly integrated in the functioning of the protocol. During the step of formation of the topology tables of the nodes of the network, the nodes distribute topology messages, called TC (Topology Control) messages, in order to declare active links. By way of example, a topology message TC is shown in FIG. 4 and comprises a field with the MSN (Message Sequence Number) number, a field with the MSSN (Message SubSystem Number) number, a metric field here corresponding to an HC (hop count) number, a reserved field (Reserve), a field with the OA (Originator Address), and MRSA (Multipoint Relay Selector Address) fields. All of the fields of the topology message TC are defined in detail in section 9 of the RFC 3626 standard. According to the invention, the topology message also comprises a link overload state (OVERLOAD) which is entered in the reserved field as shown in FIG. 4.

After reception of a topology message TC by a destination node, the latter updates its topology table to include the active link in it, and a countdown is initiated. If no TC message re-updates this information before expiry of the countdown, the link is considered to be inactive (DOWN) and is deleted from the topology table of the destination node. If another TC message relating to the link in question is received, the link remains in the active state (UP) and the countdown is re-initialized. The topology table of each node is thus updated by exchanging TC messages at regular time intervals. With the topology table obtained, a node of the meshed network can form its routing table.

By way of example, a multipoint meshed communications network 3 installed in an individual's house is shown in FIG. 3. The local network 3 comprises a home gateway T1 which is set up to connect the home network 3 to the internet network 5 through a connection 6 of the FTTH type which guarantees a high data rate of the order of one Gigabit/s.

The local network 3 furthermore comprises a television decoder (set-top box) T2 which is connected to the home gateway T1 by two links L1, L2 which respectively correspond to WiFi links 802.11n and 802.11a which are independent. In other words, the home gateway T1 and the set-top box T2 form two nodes of the local network 3 connected by two links L1, L2.

In this example, the set-top box T2 is connected, on the one hand, to an office computer 9 located on the first floor of the house and, on the other hand, to a television set 8 located on the ground floor of the house.

The home gateway T1 is itself connected to a multimedia server 7, also located on the ground floor of the house. The advantage of the WiFi links L1, L2 is that the home gateway T1 and the multimedia server 7 can be remote from the set-top box T2. In particular, the terminals can be located in different rooms.

In this example, the home gateway T1 and the set-top box T2 are supplied by a telecommunications operator and use a three-state OLSR routing protocol according to the invention in the local network 3.

As will be described in detail below, the home gateway T1 comprises means arranged for measuring the load parameter on the two wireless links L1, L2, means of comparison of the measured load parameter with a predetermined overload threshold and means for distributing to at lease some of the nodes of said network an item of information relating to said overload state of said link.

The home gateway T1 has as its IP address 192.168.0.1 and distributes topology messages TC to the other nodes of the home network 3 in order to construct the topology table of the network. According to the invention, the topology message TC comprises an item of information relating to the overload state of said link which is defined in the reserved field of said message TC as shown in FIG. 4.

In this example, the local network 3 comprises only two nodes T1, T2 each of which comprises a topology table constructed by exchange of topology messages TC.

As shown in table 1 shown below, the topology table of the home gateway T1 has one line per link. By way of example, the first line of the topology table corresponds to the link L1 and indicates that the set-top box T2, whose IP address is 192.168.0.2, is connected to the home gateway by an interface network whose address is 10.0.0.2 and whose state is active (UP). In comparison with a conventional topology table, the topology table according to the invention is enhanced by an additional column indicating the overload state of the link, referenced “T_link state” in table 1.

TABLE 1
Topology table of the home gateway T1

| | | T_link | | |
|---|---|---|---|---|
| T_dest_address | T_last_address | state | T_sequence | T_Time |
| 192.168.0.2 | 10.0.0.2 | UP | 1 | 200 |
| 192.168.0.2 | 10.0.0.6 | UP | 2 | 200 |

From the topology table shown above, the home gateway T1 forms its routing table, shown in table 2 below, in which one line corresponds to one path leading to a destination node of the network.

By way of example, the first line of the routing table shows that in order to reach the set-top box T2, whose IP address is 192.168.0.2, a data stream can be conveyed to the network interface 802.11n, whose address is 10.0.0.2, via the link L1. In comparison with a conventional routing table, the routing table according to the invention is enhanced by two additional columns indicating, on the one hand, the overload state of the paths of the network (Interface Status) and, on the other hand, the identifier of the streams flowing on said paths (Flow ID).

TABLE 2
Routing table of the home gateway
T1 with the link L1 in the UP state

| Dest @ | Next @ | iface@ | Interface status | Hop count | Flow ID |
|---|---|---|---|---|---|
| 192.168.0.2 | 10.0.0.2 | 802.11n | UP | 1 | 0 |
| 192.168.0.2 | 10.0.0.6 | 802.11a | UP | 1 | 0 |

A first stream F1 is transmitted from the home gateway T1 to the set-top box T2. After consultation of its routing table, the first stream F1 is conveyed by the home gateway T1 onto the link L1 which has a better metric than the link L2. The identifier of the first stream F1 is then stored in its routing table as shown in table 3 below.

TABLE 3
Routing table of the home gateway
T1 after storage of the stream F1

| Dest @ | Next @ | iface@ | Interface status | Hop count | Flow ID |
|---|---|---|---|---|---|
| 192.168.0.2 | 10.0.0.2 | 802.11n | UP | 1 | F1 |
| 192.168.0.2 | 10.0.0.6 | 802.11a | UP | 1 | 0 |

After the transmission of the first data stream F1, the load of the link L1 increases. The home gateway T1 measures the load parameter of the link L1 which is then equal to 80%. The home gateway T1 compares the load parameter of the link L1 with the overload threshold M. The link L1 is declared to be overloaded (OVERLOAD) whilst the other links remain active (UP). The home gateway T1 updates its topology table by indicating that the link is overloaded and distributes topology messages TC to indicate to the other nodes of the home network 3 that the link L1 is overloaded.

For this purpose, the set-top box T2 comprises means of receiving topology messages TC comprising the overload state of said link information transmitted by the home gateway T1 and means of updating its topology table from said overload state of said link information.

After the updating of its topology table, the routing table of the home gateway T1 is recalculated and the path leading to the set-top box T2 using the link L1 is indicated as being overloaded as shown in table 4 below.

TABLE 4
Routing table of the home gateway T1 with
the link L1 in the OVERLOAD state

| Dest @ | Next @ | iface@ | Interface status | Hop count | Flow ID |
|---|---|---|---|---|---|
| 192.168.0.2 | 10.0.0.2 | 802.11n | OVERLOAD | 1 | F1 |
| 192.168.0.2 | 10.0.0.6 | 802.11a | UP | 1 | 0 |

A second data stream, denoted F2 in FIG. 3, is transmitted by the home gateway T1 with the set-top box T2 as its destination. In order to convey the second stream F2, the home gateway T1 consults its routing table. As the link L1 is overloaded and as another path is available for bypassing the overloaded link, the home gateway T1 conveys the second stream F2 through the second link L2.

The routing method according to the invention makes it possible, thanks to its overload state, to use all of the capacity of the network in order to make it possible to increase the volume and the rate of data able to be transmitted between T1 and T2. The home gateway T1 stores the identifier of the second stream F2 in its routing table as shown in table 5 below.

TABLE 5
Routing table of the home gateway
T1 after storage of the stream F2

| Dest @ | Next @ | iface@ | Interface status | Hop count | Flow ID |
|---|---|---|---|---|---|
| 192.168.0.2 | 10.0.0.2 | 802.11n | OVERLOAD | 1 | F1 |
| 192.168.0.2 | 10.0.0.6 | 802.11a | UP | 1 | F2 |

Thanks to the invention, the home gateway T1 can communicate with the set-top box T2 without saturating one of the links L1, L2. Moreover, the transmission of the first data stream F1 is not disturbed by the routing method, the second data stream F2 being transmitted independently.

In a way similar to the other embodiments of the invention, in this home network 3, when a link is overloaded (OVERLOAD), a step of selection of the streams to be transmitted can be implemented: only the priority data streams can be sent on the overloaded link, the streams of lower priority being transmitted through the other paths which are not overloaded. Similarly, an active threshold can be defined in order to update the state of the overloaded link.

The method according to the invention has here been integrated with a routing protocol which corresponds to the third layer of the OSI (Open Systems Interconnection) model but an integration of the method with a path selection protocol which corresponds to the second layer of the OSI model can be derived from the above disclosure.

1. A link-state routing method for routing a data stream in a meshed communications network comprising a plurality of nodes connected by links, at least one node of said network comprising a topology table which comprises at least one link, in which the node implements:
a step of measuring a parameter relating to the load on said link,
a step of comparison of the measured load parameter with a predetermined overload threshold, an overload state being assigned to said link when said overload threshold is exceeded by said load parameter; and
a step of distributing an item of information relating to said overload state of said link to at least some of the nodes of said network.

2. The method as claimed in claim 1, wherein the node implements a step of updating its topology table from said item of information relating to the overload state of said link.

3. The method as claimed in claim 2, wherein, the node of said network comprising a routing table, constructed from the updated topology table, comprising at least one path leading to a destination node, the node implements a step of storage of the overload state of the path in the routing table.

4. The method as claimed in claim 3, wherein, when the routing table comprises a path in the overload state leading to a destination node, the node adds to its routing table another path leading to said destination node.

5. The method as claimed in claim 3, wherein the node implements a step of storage in its routing table of an identifier of a data stream flowing on said path.

6. The method as claimed in claim 1, wherein the node implements:
a step of comparison of the load parameter of said overloaded link with a predetermined active threshold, an active state being assigned to said link if said load parameter is lower than said active threshold, and
a step of updating its topology table from an item of information relating to the active state of said link.

7. A link-state routing method for routing a data stream in a meshed communications network comprising a plurality of nodes connected by links, at least one node of said network comprising a topology table which comprises at least one link, in which the node implements:
a step of receiving an item of information relating to the overload state of said link transmitted by at least one other node of the network, and
a step of updating by said node of its topology table, from said item of information relating to the overload state of said link.

8. A node of a meshed communications network comprising a plurality of nodes connected by links, the node comprising:
a topology table comprising at least one link;
means of measuring a load parameter on said link;
means of comparison of the measured load parameter with a predetermined overload threshold, an overload state being assigned to said link in the case of said load parameter exceeding said overload threshold; and
means of distributing to at least some of the nodes of said network an item of information relating to said overload state of said link.

9. A node of a meshed communications network comprising a plurality of nodes connected by links, the node comprising:
a topology table comprising at least one link;
means of receiving an item of information relative to the overload state of said link transmitted by at least one other node of the network, and
means of updating its topology table from said item of information relating to the overload state of said link.

10. A signal transmitted by a source node, of a meshed communications network comprising a plurality of nodes connected by links, to at least one destination node of said network, the destination node comprising a topology table comprising at least one link, the signal conveying a topology message intended for updating the topology table of the destination node, wherein the topology message comprises a field giving information on the overload state of said link.

11. A non-transitory computer program product comprising instructions for the implementation of the method as claimed in claim 1 when the program is executed by a processor.

12. A recording medium in which the program as claimed in claim 11 is stored.

13. A non-transitory computer program product comprising instructions for the implementation of the method as claimed in claim 7 when the program is executed by a processor.

14. A recording medium in which the program as claimed in claim 13 is stored.
